(19) United States
(12) Patent Application Publication
(10) Pub. No.: US 2024/0316866 A1
(43) Pub. Date: Sep. 26, 2024

(54) AN IMPROVED METHOD FOR 3D PRINTING

(71) Applicant: SIGNIFY HOLDING B.V., EINDHOVEN (NL)

(72) Inventor: JACOBUS PETRUS JOHANNES VAN OS, EINDHOVEN (NL)

(21) Appl. No.: 18/578,944

(22) PCT Filed: Jul. 6, 2022
(86) PCT No.: PCT/EP2022/068780

§ 371 Date: Jan. 12, 2024

(30) Foreign Application Priority Data
Jul. 16, 2021 (EP) 21186065.5

(51) Int. Cl. B29C 64/30; B29C 53/02; B29C 53/84; B29C 64/118; B29L 31/00; B33Y 10/00; B33Y 40/20; B33Y 70/00; B33Y 80/00

(52) U.S. Cl. CPC B29C 64/30; B29C 53/02; B29C 53/84; B29C 64/118; B33Y 10/00; B33Y 40/20; B33Y 70/00; B33Y 80/00; B29L 2031/7282

(57) ABSTRACT

The present invention relates to a method for manufacturing a 3D article (1) by means of 3D printing, the method comprising the steps of: a) printing a 3D structure (1′) extending in a first plane and comprising a first surface (4) and a second surface (4′) being opposite to the first surface (4); b) cooling the 3D structure (1′); c) heating the one of the first and the second surfaces (4, 4′) of the 3D structure (1′); d) deforming the 3D structure (1′) in a second plane deviating from the first plane, such that a 3D article (1) is obtained; c) cooling the 3D article (1).

### TECHNICAL FIELD

The present invention relates to an improved method for manufacturing a 3D article by means of 3D printing, and to a 3D article manufactured by the improved method.

### BACKGROUND

Fused Deposition Modelling (FDM) is one of the most frequently used techniques for producing objects based on additive manufacturing (3D printing). FDM works on an “additive” principle by applying plastic material in layers. In particular, FDM may be used for printing lamp shades.

3D printing enables a huge variety of designs. It is known that many thinkable shapes which are designed in a CAD process can be printed. However, 3D printing has a number of limitations.

The optimal way of printing with FDM is to design shapes which can be printed with a continuous lines design. Such shapes provide strong products, are easily printable and offer reliable yield in production. According to the current state of the art, printing is normally started in an X-Y plane. All design features in Z-plane which the distance H are easily obtainable. However, if there are multiple areas protruding beyond the distance H in Z-plane, printing becomes complicated. Thus, the printer has to stop the extrusion, move to the next area protruding beyond the distance H, and start printing again for a short time. This process is repeated until the end of the print, which is time-consuming and expensive. Further, interruptions in the printing process result in lower quality, since interruptions without any visual anomaly are hard to achieve.

Overhang printing is another well-known challenge in 3D printing. Currently, such features are printed by carefully tuning the process in terms of speed and temperature. In particular, printing has to be slow, and the temperature has to be optimized and controlled. Creating apertures in the overhang parts of the print is virtually impossible with the current state of 3D printing. This invention overcomes this problem by a fast and cheap way of printing.

Therefore, it is desirable to provide an improved method for 3D printing that remedies the shortcomings of the current methods, and that enables simple and cost-efficient printing of complex 3D articles.

### SUMMARY

In view of the above discussion, the present invention provides a method for manufacturing a 3D article by means of 3D printing. The method according to the present invention comprising the steps of:
a) printing a 3D structure extending in a first plane and comprising a first surface and a second surface being opposite to the first surface;
b) cooling the 3D structure;
c) heating the one of the first and the second surfaces of the 3D structure;
d) deforming the 3D structure in a second plane deviating from the first plane, such that a 3D article is obtained;
e) cooling the 3D article.

Therefore, the method of the present invention offers the advantage of providing a cost-efficient and fast way of printing complex 3D articles comprising portions that may otherwise be difficult or impossible to create using conventional methods. The general idea of the present invention is that the complex 3D article is printed as a 3D structure, which is then rearranged into the desired 3D shape. Printing is performed on a horizontal print bed. After finishing 3D printing, the 3D structure is heated until the lower layers are soft. In this soft state, specific parts of the 3D structure are deformed in at least one second plane, such that a 3D article is obtained. Such a deformation may be bending snap-fit locking devices from a horizontal to a vertical plane or bulging a flat print into a dome.

The printing in step a) may be performed by any suitable method known to the person skilled in the art, such as a single additive manufacturing process, e.g. fused deposition modelling (FDM).

Cooling of the 3D structure obtained in step a) may be performed by any conventional method, such as air cooling using natural convection or a fan, or water cooling by submersing the 3D structure in a water bath. Cooling time as well as the final temperature of the 3D structure at the end of step b) may vary depending on the material used but should be sufficient enough to obtain a substantially solid 3D structure.

Step c) may be performed by arranging the one of the first and the second surfaces of the 3D structure on a heating plate. Heating time as well as the final temperature of the 3D structure at the end of step c) may vary depending on the material used, but should be sufficient enough to obtain a substantially soft surface such that step d) may be performed, as will be described in greater detail below. In particular, step c) may be performed at a temperature from 120° C. to 180° C. Indeed, step c) should not result in complete melting of the 3D structure, or in excessive softening such that the structural integrity of the 3D structure is compromised.

During step d), the 3D structure is deformed in at least one second plane deviating from the first plane, such that a 3D article is obtained. The second plane may be substantially perpendicular to the first plane. Alternatively, the second plane may be arranged at any other angle in relation to the first plane. It should be noted that during step d) the 3D structure may be deformed in a plurality of second planes. The angle between the first plane and each of the plurality of second planes may be same or different. Such an embodiment may be desirable when the 3D structure is in the shape of a box or the like.

Deforming in the context of the present invention may be performed by any suitable method, such as bending, pushing, pulling, blowing, sucking or the like.

The method according to the present invention may further comprise step d′) of stretching the 3D structure, wherein step d′) occurs between step c) and step e). Thus, step d′) may be occur before, after or simultaneously with step d). In other words, the 3D structure obtained during step a) may be both deformed and stretched, thus allowing to create complex printed 3D articles in a simple and efficient manner. By the term “complex” is understood as a structure comprising a developable or a non-developable portion. In the context of the present invention, a developable surface is a smooth surface with zero Gaussian curvature. A Gaussian curvature is defined as a product of two principal curvatures of a surface. Put differently, a developable surface is a non-flat surface that can be flattened onto a plane without distortion, i.e. it can be bent without stretching or compression. Conversely, it is a surface which can be made by transforming a plane by means of folding, bending, rolling, cutting and/or gluing. Examples of a developable surface are cylinders and cones.

On the contrary, a non-developable surface is a surface with non-zero Gaussian curvature. A non-developable surface is thus a non-flat surface that cannot be flattened onto a plane without distortion. Most of surfaces in general are non-developable surfaces. Non-developable surfaces may be referred to as doubly curved surfaces. One of the most often-used non-developable surfaces is a sphere.

In order to facilitate step d), the method according to the present invention may comprise step a′) of printing at least one bending tool. Step a′) may occur simultaneously with or immediately after step a). Alternatively, step a′) may occur at any other point. The bending tool defines the angle of bending and may be printed with the same printing process as the 3D structure. Such a step a′) is particularly advantageous when the 3D article is reproduced.

The present invention further relates to a 3D article manufactured by the method described above. The 3D article comprises a first portion extending in a first plane and at least one second portion substantially extending in a second plane deviating from the first plane. As mentioned above, the second plane may be substantially perpendicular to the first plane. Alternatively, the second plane may be arranged in any other angle in relation to the first plane.

In a particular embodiment, the 3D article may comprise a discontinuous second portion. Thus, the at least one second portion of the 3D article may be constituted by at least one snap-fit locking device. For instance, the 3D article may be an annular element comprising snap-fit protrusions arranged perpendicularly to the plane of the ring. Further, the at least one second portion of the 3D article may comprise at least one aperture. The size and shape of the at least one aperture may be varied according to the intended design of the 3D article. In particular, the 3D article may be substantially dome-shaped, and may comprise a plurality of apertures. Such a 3D article may be used as a decorative lamp shade.

The 3D article may comprise a UV stabilizer arranged to inhibit photodegradation. By “photodegradation” is meant alteration of chemical and/or physical properties of a material by light. In case of a polymeric material, photodegradation normally includes oxidative scission of the polymer as well as radical cross-linking, causing deterioration of mechanical properties, in particular loss of flexibility, embrittlement as well as discoloration.

The UV stabilizer may be selected from the group consisting of UV absorbers, quenchers, hindered amine light stabilizers (HALS) and mixtures thereof. UV absorbers function by competing with the chromophores to absorb UV radiation. UV absorbers transform harmful UV radiation into harmless infrared radiation or heat that is dissipated through the material matrix. UV absorbers have the benefit of low cost but may be useful only for short-term exposure. UV absorbers may be selected from the group consisting of carbon black, rutile titanium oxide, benzophenones, benzotriazoles and mixtures thereof. Quenchers, e.g. nickel quenchers, return excited states of the chromophores to ground states by an energy transfer process. This prevents bond cleavage and ultimately the formation of free radicals. HALS are long-term thermal stabilizers that act by trapping free radicals formed during the photo-oxidation of a material, thus inhibiting photodegradation process. Although there are wide structural differences in the HALS products commercially available, they all share the 2,2,6,6-tetramethylpiperidine ring structure. HALS are some of the most proficient stabilizers for UV radiation.

The 3D article of the present invention may comprise polycarbonate (PC), acrylate-styrene-acrylonitrile (ASA), acrylonitrile-butadiene-styrene (ABS), polypropylene (PP), high density polyethylene (HDPE), polymethyl methacrylate (PMMA), polyethylene terephthalate (PET), polyethylene furanoate (PEF) or mixtures thereof. In particular, the 3D article of the present invention may comprise thermoplastic biopolymer or a recycled polymeric material. Such an embodiment offers the advantage of providing an environmentally friendly 3D article. By the term “thermoplastic biopolymer” is meant a polymer originating from biomass resources such as cellulose, lignin, and chitin. Such a polymer may require chemical and physical modification techniques in order to induce thermoplasticity. Modification techniques focus on masking the hydroxyl groups to disrupt dense hydrogen bonding and so enable polymer chain mobility upon heating. Thus, introduction of long alkyl chains into the polymer backbone effectively improves the thermoplastic processing of natural polymers.

The 3D article may further comprise a coating. The coating may comprise several layers and may be arranged for improving aesthetical appearance, providing additional UV resistance, and preventing penetration of fluid and/or gas. The thickness of the 3D article may be from 0.5 to 5 mm. Further, the 3D article May comprise a reinforcing additive, e.g. glass fibers, arranged to increase the impact strength of the 3D article.

If the 3D article of the present invention is intended for outdoor use, the 3D article may comprise an herbicide or a pesticide in order to prevent growth of algae and other biological species on 3D article, which otherwise may lead to deterioration of the outer layer of the 3D article and also negatively affect the aesthetical appearance. The 3D article may be self-cleaning and/or may comprise a substance that facilitates cleaning.

### BRIEF DESCRIPTION OF THE DRAWINGS

Embodiments of the invention will now be described by way of example with reference to the accompanying drawings, of which:

FIGS. 1a and 1b depict a 3D article comprising a plurality of vertical snap-fit locking arrangements;

FIGS. 2a through 4b illustrate shallow dome shapes with integrated apertures.

All the figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical reference numerals denote the same or similar components having a same or similar function, unless specifically stated otherwise.

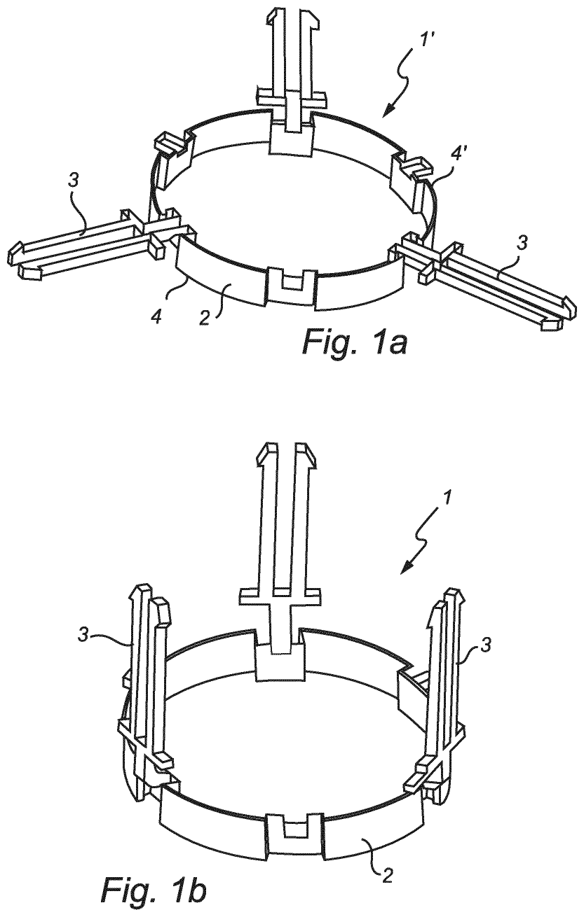

FIG. 1a shows a 3D structure l′ extending in a first plane and comprising a first surface 4 and a second surface 4′ being opposite to the first surface. The 3D structure is obtained by steps a) and b) of the method according to the present invention. The 3D structure comprises a first portion 2 and a second portion 3 extending from the first surface 4 in a first plane.

Next, steps c) and d) are performed, wherein the first surface 4 of the 3D structure 1′ is heated, and the second portion 3 of the 3D structure 1′ is deformed in a second plane deviating from the first plane, such that a 3D article 1 is obtained and cooled according to step e).

As may be seen in FIG. 1b, the second plane is substantially perpendicular to the first plane. The 3D article 1 comprises a discontinuous second portion 3, being constituted by three snap-fit locking devices. The 3D article 1 is thus an annular element comprising snap-fit protrusions arranged perpendicularly to the plane of the ring.

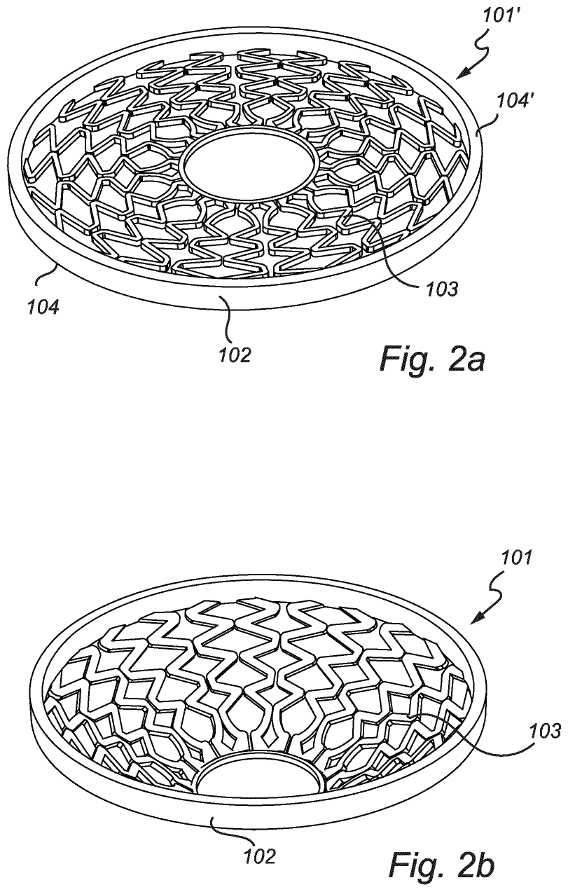

Turning the attention to FIG. 2a, another 3D structure 101′ is shown. The 3D structure 101′ extends in a first plane and comprises a first surface 104 and a second surface 104′ being opposite to the first surface. The 3D structure is obtained by steps a) and b) of the method according to the present invention. The 3D structure comprises a first portion 102 and a second portion 103 extending from the first surface 104 in a first plane.

Next, steps c) and d) are performed, wherein the first surface 104 of the 3D structure 101′ is heated, and the second portion 103 of the 3D structure 101′ is deformed in a second plane deviating from the first plane, such that a 3D article 101 is obtained and cooled according to step e).

As may be seen in FIG. 2b, the 3D article 101 comprises a discontinuous second portion 103, being constituted by a dome shape comprising a plurality of apertures.

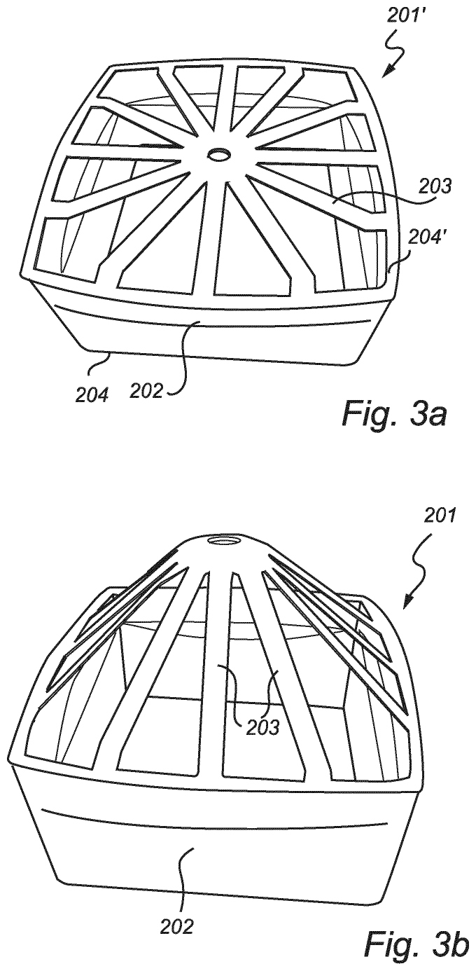

FIGS. 3a and 3b show another embodiment of the present invention. The 3D structure 201′ extends in a first plane and comprises a first surface 204 and a second surface 204′ being opposite to the first surface. The 3D structure is obtained by steps a) and b) of the method according to the present invention. The 3D structure comprises a first portion 202 and a second portion 203 extending from the second surface 204′ in a first plane.

Next, steps c) and d) are performed, wherein the second surface 204′ of the 3D structure 201′ is heated, and the second portion 203 of the 3D structure 201′ is deformed in a second plane deviating from the first plane, such that a 3D article 201 is obtained and cooled according to step e).

As may be seen in FIG. 3b, the 3D article 201 comprises a discontinuous second portion 203, being constituted by a dome shape comprising a plurality of apertures.

The method for manufacturing the 3D article 201 comprises step d′) of stretching the 3D structure 201′ beyond elongation at room temperature. Also, at elevated temperature the forces needed for deformation are reduced.

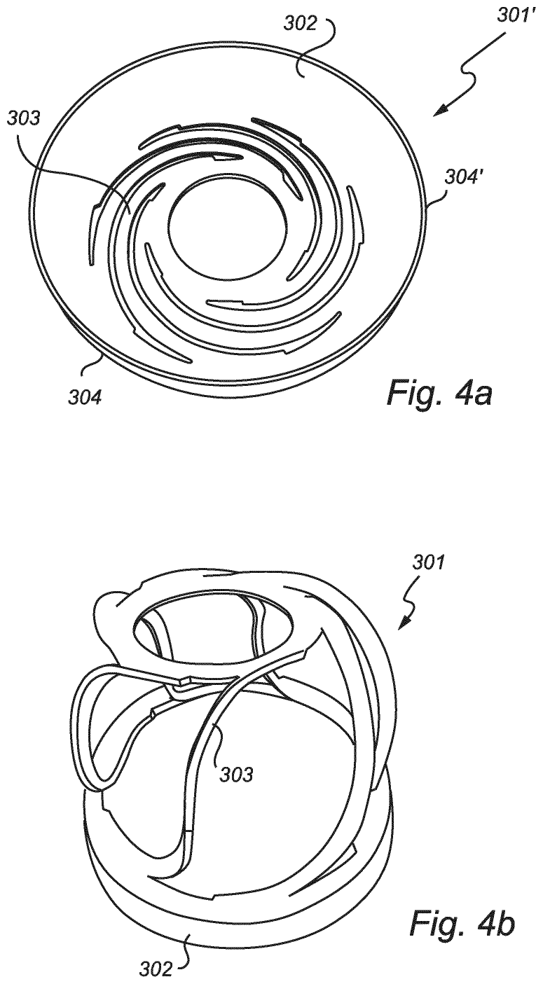

Finally, FIGS. 4a and 4b illustrate yet another embodiment of the present invention. The 3D structure 301′ extends in a first plane and comprises a first surface 304 and a second surface 304′ being opposite to the first surface. The 3D structure is obtained by steps a) and b) of the method according to the present invention. The 3D structure comprises a first portion 302 and a second portion 303 extending from the first surface 304 in a first plane.

Next, steps c) and d) are performed, wherein the first surface 304 of the 3D structure 301′ is heated, and the second portion 303 of the 3D structure 301′ is deformed in a second plane deviating from the first plane, such that a 3D article 301 is obtained and cooled according to step e).

As may be seen in FIG. 4b, the 3D article 301 comprises a discontinuous second portion 303, being constituted by a dome shape comprising a plurality of apertures.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention. While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method for manufacturing a 3D article by means of 3D printing, said method comprising the steps of:
a) printing a 3D structure comprising a first surface and a second surface being opposite to said first surface, the 3D structure comprising a portion extending from one of the first surface and the second surface in a first plane;
b) cooling said 3D structure;
c) heating said one of said first and said second surfaces of said 3D structure;
d) deforming said 3D structure, by means of bending the portion in a second plane deviating from said first plane, such that the 3D article is obtained;
e) cooling said 3D article,
wherein the method further comprises the step of:
a′) printing at least one bending tool for defining an angle of bending.

2. The method according to claim 1, wherein said printing in step a) is performed by fused deposition modelling.

3. The method according to claim 1, wherein step c) is performed by arranging said one of said first and said second surfaces of said 3D structure on a heating plate.

4. The method according to claim 1, wherein step c) is performed at a temperature from 120° C. to 180° C.

5. The method according to claim 1, wherein said method further comprises step d′) of stretching said 3D structure, wherein step d′) occurs between step c) and step e).

6. The method according to claim 1, wherein step a′) occurs simultaneously with or immediately after step a).

7. A 3D article manufactured by the method according to claim 1, wherein said 3D article comprises a first portion extending in a first plane and at least one second portion substantially extending in a second plane deviating from said first plane.

8. The 3D article according to claim 7, wherein said second portion of said 3D article comprises at least one aperture.

9. The 3D article according to claim 7, wherein said second portion of said 3D article is discontinuous.

10. The 3D article according to claim 7, wherein said second portion of said 3D article is constituted by at least one snap-fit locking device.

11. The 3D article according to claim 7, wherein said 3D article is substantially dome-shaped.

12. The 3D article according to claim 7, wherein said 3D article comprises a UV stabilizer arranged to inhibit photodegradation.

13. The 3D article according to claim 7, wherein said 3D article comprises thermoplastic biopolymer.

14. The 3D article according to claim 7, wherein said 3D article has a thickness of from 0.5 to 5 mm.

15. The 3D article according to claim 7, wherein said 3D article comprises a reinforcing additive arranged to increase the impact strength of said 3D article.
